(19) United States
(12) Patent Application Publication
(10) Pub. No.: US 2010/0190880 A1
(43) Pub. Date: Jul. 29, 2010

(54) LOW-DENSITY POLYURETHANE FOAMS AND USE THEREOF IN SHOE SOLES

(75) Inventors: Andre Kamm, Lemfoerde (DE); Markus Schuette, Osnabrueck (DE); Holger Haschke, Wagenfeld (DE); Tony Spitilli, Torino (IT)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE., LUDWIGSHAFEN (DE)

(21) Appl. No.: 12/678,540

(22) PCT Filed: Sep. 29, 2008
(86) PCT No.: PCT/EP08/62985

§ 371 Date: Mar. 17, 2010

(30) Foreign Application Priority Data
Oct. 2, 2007 (EP) 07117767.9

(51) Int. Cl. C08L 75/08

(52) U.S. Cl. 521/137

(57) ABSTRACT

The present invention relates to a process for the production of a polyurethane molding having a density of 150 to 350 g/L, in which a) polyisocyanate prepolymers, obtainable from a polyisocyanate component (a-1), polyol (a-2), comprising polypropylene oxide, and chain extender (a-3), b) polyetherpolyols having a functionality greater than 2.0, c) polymer polyetherpolyols, d) chain extender, e) catalysts, f) blowing agent, comprising water, and, if appropriate, g) other assistants and/or additives are mixed with a reaction mixture and cured in a mold to give the polyurethane molding. The present invention furthermore relates to polyurethane moldings obtainable by a process according to the invention and to shoe soles comprising polyurethane moldings according to the invention.

The present invention relates to a process for the production of a polyurethane molding having a density of 150 to 350 g/L, in which a) polyisocyanate prepolymers, obtainable from a polyisocyanate component (a-1), polyol (a-2), comprising polypropylene oxide, and chain extender (a-3), b) polyetherpolyols having an average functionality greater than 2.0, c) polymer polyetherpolyols, d) chain extender, e) catalysts, f) blowing agent, comprising water, and, if appropriate, g) other assistants and/or additives are mixed with a reaction mixture and cured in a mold to give the polyurethane molding. The present invention furthermore relates to polyurethane moldings obtainable by a process according to the invention and to shoe soles comprising polyurethane moldings according to the invention.

Further embodiments of the present invention are described in the claims, the description and the examples. Of course, the abovementioned features of the subject of the present invention and those still to be explained below can be used not only in the combination stated in each case but also in other combinations without departing from the scope of the invention.

Elastic polyurethane moldings having a compact surface and cellular core, so-called flexible integral polyurethane foams, have long been known and are used in various areas. A typical use is that as shoe soles, for example for street shoes, sports shoes, sandals and boots. In particular, flexible integral polyurethane foams can be used in the production of outsoles, midsoles, insoles and molded soles.

For comfort and cost reasons, a reduction in the densities of the shaped polyurethane articles is strived for. It is thus necessary to develop flexible integral polyurethane foams which, in spite of low densities, have sufficient mechanical properties, such as hardness and elasticity, but also good processing properties, such as high dimensional stability and a load frequency of defects. Usually, the decline in these properties is further promoted by an increased proportion of water in the formulation for the production of the shaped articles, which replaces environmentally harmful blowing agents. For this reason, it has not been possible to date for shoe soles comprising polyurethane (PU) having densities lower than 300 g/L to successfully compete with materials such as, for example, poly(ethylene-co-vinyl acetate) (EVA), for example, for sports shoes.

The polyurethane moldings based on polyesters, shoe soles having a density lower than 400 g/L are known. Thus, WO 2005/116101 discloses flexible integral polyurethane foams based on polyesters having a density lower than 400 g/L, obtainable using a combination of polyester polyol and polymer polyesterol. According to WO 2005/116101, such polyurethane moldings can also be used as shoe soles.

However, polyester-based flexible integral polyurethane foams show aging behavior worthy of improvement under humid warm conditions. It is known that flexible integral polyurethane foams based on polyethers show improved hydrolysis aging behavior.

WO 91/17197 discloses that the use of polyols based on poly(oxytetramethylene) is advantageous for preparing PU foams having densities of from 100 to 1000 g/L. EP 1042384 teaches that the use of poly(oxytetramethylene) and polymer polyols substantially improves the processing properties. Thus, EP 1042384 shows that, with densities of from 150 to 500 g/L, absolutely no peeling of the skin layer or problems with the dimension stability occur. The disadvantage of this method is the substantially higher price of poly(oxytetramethylene) in comparison with conventional polyols which are prepared via KOH catalyzed reaction.

WO 97/44374 describes the use of polyetherpolyols prepared by means of DMC catalysis (also referred to below as DMC polyetherpolyols) for the preparation of flexible integral polyurethane foams having densities of from 200 to 350 g/L. These flexible integral polyurethane foams can also be used as shoe soles. The disadvantage of the DMC polyetherpolyols is that, as a result of the preparation, they have only secondary OH groups and, owing to the low reactivity, can be used exclusively on the prepolymers. Polyurethane moldings having a low density and good mechanical properties cannot be obtained in this manner.

WO 00/18817 explains the production of low-density polyurethane moldings using DMC polyetherpolyols with an ethylene oxide endcap, with the result that polyols having primary OH groups are obtained. These polyols can be used both in the polyol component and in the prepolymer. The disadvantage of these polyols is that DMC polyols having an EO endcap are prepared via a complicated hybrid process.

EP 582 385 discloses flexible integral polyurethane foams having a density of from 200 to 350 g/L and water as the sole blowing agent. The preparation is effected starting from a polyether polyol and an isocyanate prepolymer based on organic polyisocyanates and polyetherpolyols. What is disadvantageous about flexible integral polyurethane foams according to EP 582385 is that they have poor mechanical properties, such as only limited hardness and a low tensile strength, and poor processing properties and a poor skin quality.

It was therefore an object of the present invention to provide an economical process for the preparation of hydrolysis-stable flexible integral polyurethane foams having a density of from 150 to 350 g/L and outstanding mechanical properties and very good processability.

The object according to the invention is achieved by a process for the preparation of flexible integral polyurethane foams having a density of from 150 to 350 g/L, in which a) polyisocyanate prepolymers, obtainable from a polyisocyanate component (a-1), polyol (a-2), containing polypropylene oxide, and chain extender (a-3), b) polyetherpolyols having an average functionality greater than 2.0, c) polymer polyetherpolyols, d) chain extender, e) catalysts, f) blowing agent, comprising water, and, if appropriate, g) other assistants and/or additives are mixed to a reaction mixture and this is cured in a mold.

The object according to the invention is furthermore achieved by flexible integral polyurethane foams which can be prepared by a process according to the invention.

Flexible integral polyurethane foams are understood as meaning polyurethane foams according to DIN 7726 having a cellular core and compact surface, the edge zone having a higher density than the core owing to the shaping process. The overall gross density averaged over the core and the edge zone is from 150 to 350 g/L, preferably from 150 to 300 g/L and in particular from 200 to 300 g/L. In a preferred embodiment, the invention relates to flexible integral polyurethane foams based on polyurethanes having an Asker C hardness in the range of 20-90, preferably from 35 to 70 Asker C, in particular from 45 to 60 Asker C, measured according to ASTM D 2240. Furthermore, the flexible integral polyurethane foams according to the invention preferably have tensile strengths of from 0.5 to 10 N/mm², preferably from 1 to 5 N/mm², measured according to DIN 53504. Furthermore, the flexible integral polyurethane foams according to the invention preferably have an elongation of from 100 to 800%, preferably from 180 to 500, measured according to DIN 53504. Furthermore, the flexible integral polyurethane foams according to the invention preferably have a resilience according to DIN 53 512 of from 10 to 60%. Finally, the flexible integral polyurethane foams according to the invention preferably have a tear propagation strength of from 0.5 to 10 N/mm, preferably from 1.0 to 4 N/mm, measured according to ASTM D3574.

The polyisocyanate prepolymers a) used for the preparation of flexible integral polyurethane foams are obtainable from a polyisocyanate component (a-1), polyol (a-2), containing polypropylene, and chain extender (a-3). These polyisocyanate prepolymers a) are obtainable by reacting polyisocyanates (a-1), for example at temperatures from 30 to 100° C., preferably at about 80° C., with polyols (a-2), containing polypropylene oxide, and chain extender (a-3) to give the prepolymer. The ratio of isocyanate groups to groups reactive with isocyanate is chosen here so that the NCO content of the prepolymer is from 8 to 28% by weight, preferably from 14 to 26% by weight, particularly preferably from 16 to 23% by weight and in particular from 16 to 20% by weight. In order to exclude secondary reactions by atmospheric oxygen, the reaction can be carried out under inert gas, preferably nitrogen.

Polyisocyanates (a-1) which may be used are the aliphatic, cycloaliphatic and aromatic di- or polyvalent isocyanates known from the prior art, and any desired mixtures thereof. Examples are diphenylmethane 4,4″-diisocyanate, the mixtures of monomeric diphenylmethane diisocyanates and homologs of diphenylmethane diisocyanate which have a larger number of nuclei (polymer MDI), tetramethylene diisocyanate, hexamethylene diisocyanate (HDI), tolylene diisocyanate (TDI), naphthalene diisocyanate (NDI) or mixtures thereof.

4,4′-MDI and/or HDI is preferably used. The particularly preferably used 4,4′-MDI may comprise small amounts, up to about 10% by weight, of allophanate or uretonimine-modified polyisocyanates. It is also possible to use small amounts of polyphenylenepolymethylene polyisocyanate (crude MDI). The total amount of isocyanate molecules having a functionality greater than 2 should not exceed 5% by weight of the total mass of the isocyanate used.

Ether-based polyols comprising polypropylene oxide are preferably used as polyols (a-2). For example polyols based on polyethylene oxide and/or copolyols based on polypropylene oxide and polyethylene oxide can be used in addition to polypropylene oxide. The average functionality of the polyols (a-2) used is preferably from 1.7 to 3.5, particularly preferably from 1.9 to 2.8 and the number-average molecular weight is from 500 to 10 000 g/mol, preferably from 1000 to 7000 g/mol and in particular from 1750 to 4500 g/mol. Preferably, the polyol (a-2) comprises at least 80% by weight, particularly preferably at least 90% by weight and in particular 100% by weight of polypropylene oxide, based in each case on the total weight of the polyol (a-2).

The preparation of the polyols (a-2) is generally effected by the generally known base-catalyzed addition reaction of propylene oxide, alone or as a mixture with ethylene oxide, with H-functional, in particular OH-functional, initiators. Initiators used are, for example, water, ethylene glycol or propylene glycol or glycerol or trimethylolpropane.

Suitable chain extenders (a-3) for the prepolymer are dihydric or trihydric alcohols, preferably branched dihydric or trihydric alcohols having a molecular weight of less than 450 g/mol, particularly preferably less than 400 g/mol, in particular less than 300 g/mol. The proportion of the chain extender, based on the total weight of the polyisocyanate prepolymers (a), is preferably from 0.1 to 10% by weight, particularly preferably from 0.5 to 5% by weight and in particular from 2 to 4% by weight. Chain extenders (a-3) preferably comprise tripropylene glycol. Particularly preferably used chain extenders (a-3) are dipropylene glycol and/or tripropylene glycol and adducts of dipropylene glycol and/or tripropylene glycol with alkylene oxides, preferably propylene oxide, or mixture thereof. In particular, exclusively tripropylene glycol is used as chain extender (a-3).

Polyetherpolyols (b) used are polyetherpolyols having an average functionality greater than 2.0. Suitable polyetherpolyols can be prepared by known processes, for example by anionic polymerization with alkali metal hydroxides, such as sodium or potassium hydroxide, or alkali metal alcoholates, such as sodium methylate, sodium or potassium ethylate or potassium isopropylate, or by cationic polymerization using Lewis acids, such as antimony pentachloride and boron fluoride etherate, as catalysts and with addition of at least one initiator which preferably comprises from 2 to 4 bound reactive hydrogen atoms per molecule, from one or more alkylene oxides having preferably 2 to 4 carbon atoms in the alkylene radical.

Suitable alkylene oxides are, for example, 1,3-propylene oxide, 1,2- or 2,3-butylene oxide and preferably ethylene oxide and 1,2-propylene oxide. The alkylene oxides can be used individually, alternately in succession or as mixtures. Suitable initiator molecules are, for example, water or dihydric and trihydric alcohols, such as ethylene glycol, 1,2- and 1,3-propanediol, diethylene glycol, dipropylene glycol, 1,4-butanediol, glycerol or trimethylolpropane.

The polyetherpolyols, preferably polyoxypropylene and polyoxypropylene-polyoxyethylene polyols, have an average functionality of preferably from 2.01 to 3.50, particularly preferably from 2.25 to 3.10 and very particularly preferably from 2.4 to 2.8. In particular, polyetherpolyols which were obtained exclusively starting from trifunctional initiator molecules are used. The molecular weights of the polyetherpolyols b) are preferably from 1000 to 10 000, particularly preferably from 1800 to 8000 and in particular from 2400 to 6000 g/mol.

Preferably, polyetherpolyols based on propylene oxide, which have ethylene oxide units bound in the terminal position, are used. The content of ethylene oxide units bound in the terminal position is preferably from 10 to 25% by weight, based on the total weight of the polyetherpolyol b).

Polymer polyetherpolyols c) used are polyetherpolyols which usually have a content of, preferably thermoplastic, polymers of from 5 to 60% by weight, preferably from 10 to 55% by weight, particularly preferably from 30 to 55% by weight and in particular from 40 to 50% by weight. These polymer polyetherpolyols are known and are commercially available and are usually prepared by free radical polymerization of olefinically unsaturated monomers, preferably acryloniltrile or styrene, and, if appropriate, further monomers, a macromer and, if appropriate, a moderator, using a free radical initiator, generally azo or peroxide compounds, in a polyetherol as a continuous phase. The polyetherol which represents the continuous phase is frequently referred to as carrier polyol. The U.S. Pat. No. 4,568,705, U.S. Pat. No. 5,830,944, EP 163188, EP 365986, EP 439755, EP 664306, EP 622384, EP 894812 and WO 00/59971 may be mentioned here by way of example for the preparation of polymer polyols.

Usually, this is an in situ polymerization of acrylonitrile, styrene or preferably mixtures of styrene and acrylonitrile, for example in the weight ratio of from 90:10 to 10:90, preferably from 70:30 to 30:70.

Suitable carrier polyols are all poyether-based polyols, preferably those as described under b). Macromers, also referred to as stabilizers, are linear or branched polyetherols having molecular weights greater than or equal to 1000 g/mol, which comprise at least one terminal, reactive olefinic unsaturated group. The ethylenically unsaturated group can be attached to an already existing polyol via reaction with carboxylic anhydrides, such as maleic anhydride, fumaric acid, acrylate and methacrylate derivatives and isocyanate derivatives, such as 3-isopropenyl-1,1-dimethylbenzyl isocyanate, or isocyanatoethyl methacrylate. A further route is the preparation of a polyol by alkoxydation of propylene oxide and ethylene oxide using initiator molecules having hydroxyl groups and an ethylenically unsaturated function. Examples of such macromers are described in the documents U.S. Pat. No. 4,390,645, U.S. Pat. No. 5,364,906, EP 0461800, U.S. Pat. No. 4,997,857, U.S. Pat. No. 5,358,984, U.S. Pat. No. 5,990,232, WO 01/04178 and U.S. 6013731.

During the free-radical polymerization, the macromers are incorporated into the copolymer chain. Block copolymers having a polyether block and a poly-acrylonitrile-styrene block, which act as a phase mediator in the interface between continuous phase and dispersed phase and suppress the agglomeration of the polymer polyol particles, form thereby. The proportion of the macromers is usually from 1 to 15% by weight, preferably from 3 to 10% by weight, based on the total weight of the monomers used for the preparation of the polymer polyol.

For the preparation of polymer polyols, moderators, also referred to as chain extenders, are usually used. The moderators reduce the molecular weight of the forming copolymers by chain transfer of the growing free radical, with the result that the crosslinking between the polymer molecules is reduced, which influences the viscosity and the dispersion stability and the filterability of the polymer polyols. The proportion of moderators is usually from 0.5 to 25% by weight, based on the total weight of the monomers used for the preparation of the polymer polyol. Moderators which are usually used for the preparation of polymer polyols are alcohols, such as 1-butanol, 2-butanol, isopropanol, ethanol, methanol, cyclohexane, toluene, mercaptans, such as ethanethiol, 1-heptanethiol, 2-octanethiol, 1-dodecanethiol, thiophenol, 2-ethylhexyl thioglycolate, methyl thioglycolate, cyclohexyl mercaptan and enol ether compounds, morpholines and α-(benzoyloxy)styrene. Alkyl mercaptan is preferably used.

Peroxide or azo compounds, such as dibenzoyl peroxide, lauroyl peroxide, tert-amyl peroxy-2-ethylhexanoate, di-tert-butyl peroxide, diisopropyl peroxide carbonate, tert-butyl peroxy-2-ethylhexanoate, tert-butyl perpivalate, tert-butyl perneodecanoate, tert-butyl perbenzoate, tert-butyl percrotonate, tert-butyl perisobutyrate, tert-butyl peroxy-1-methylpropanoate, tert-butyl peroxy-2-ethylpentanoate, tert-butyl peroxyoctanoate and di-tert-butyl perphthalate, 2,2′-azobis(2,4-dimethylvaleronitrile), 2,2′-azobisisobutyronitrile (AIBN), dimethyl-2,2′-azobisisobutyrate, 2,2′-azobis(2-methylbutyronitrile) (AMBN) and 1,1′-azobis(1-cyclohexanecarbonitrile), are usually used for initiating the free radical polymerization. The proportion of the initiators is usually from 0.1 to 6% by weight, based on the total weight of the monomers used for the preparation of the polymer polyol.

The free radical polymerization for the preparation of the polymer polyols is usually carried out at temperatures of from 70 to 150° C. and a pressure up to 20 bar, owing to the reaction rate of the monomers and the half-life of the initiators. Preferred reaction conditions for the preparation of polymer polyols are temperatures of from 80 to 140° C. at a pressure from atmospheric pressure to 15 bar.

Polymer polyols are prepared in continuous processes using stirred tanks with continuous feed and discharge, stirred tank cascades, tubular reactors and loop reactors with continuous feed and discharge, or in batchwise processes by means of a batch reactor or of a semibatch reactor.

The proportion of polymer poyletherpolyol (c) is preferably greater than 5% by weight, based on the total weight of the components (b) and (c). The polymer polyetherpolyols may be present, for example, in an amount of from 7 to 90% by weight or from 11 to 80% by weight, based on the total weight of the components (b) and (c).

Chain extenders and/or crosslinking reagents (d) used are substances having a molecular weight of less than 500 g/mol, preferably from 60 to 400 g/mol, chain extenders having two hydrogen atoms reactive towards isocyanates and crosslinking agents having three hydrogen atoms reactive toward isocyanate. These may be used individually or preferably in the form of mixtures. Preferably, diols and/or triols having molecular weights of less than 400, particularly preferably from 60 to 300 and in particular from 60 to 150 are used. For example, aliphatic, cycloaliphatic and/or araliphatic diols having 2 to 14, preferably 2 to 10, carbon atoms, such as 1,3-propanediol, 1,10-decanediol, 1,2-, 1,3- and 1,4-dihydroxycyclohexane, diethylene glycol, dipropylene glycol and preferably monoethylene glycol, 1,4-butanediol, 1,6-hexanediol and bis(2-hydroxyethyl)hydroquinone, triols, such as 1,2,4- and 1,3,5-trihydroxycyclohexane, glycerol, diethanolamine, triethanolamine and trimethylolpropane, and low molecular weight polyalkylene oxides containing hydroxyl groups and based on ethylene oxide and/or 1,2-propylene oxide and the abovementioned diols and/or triols are suitable as initiator molecules. Monoethylene glycol or 1,4-butanediol is particularly preferably used as chain extender (d). In a further preferred embodiment, the proportion of either monoethylene glycol or 1,4-butanediol is at least 70% by weight, based on the total weight of chain extender and/or crosslinking agent (d). In particular, a mixture of monoethylene glycol and 1,4-butanediol is used, the weight ratio of monoethylene glycol and 1,4-butanediol preferably being from 1:4 to 4:1.

If chain extenders, crosslinkers or mixtures thereof are used, they are expediently used in amounts of from 1 to 60% by weight, preferably from 1.5 to 50% by weight and in particular from 2 to 40% by weight, based on the weight of the components (b), (c) and (d).

Catalysts (e) used for the preparation of the polyurethane foams are preferably compounds which greatly accelerate the reaction of those compounds of component (b) and, if appropriate, (c) which comprise reactive H atoms with the polyisocyanate prepolymers (a). Amidines, such as 2,3-dimethyl-3,4,5,6-tetrahydropyrimidine, tertiary amines, such as triethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diazabicyclo[2.2.2]octane, and alkanolamine compounds, such as triethanolamine, triisopropanolamine, N-methyl- and N-ethyldiethanolamine and dimethylethanolamine, may be mentioned by way of example. Organic metal compounds, preferably organic tin compounds, such as tin(II) salts of organic carboxylic acids, e.g. tin(II) acetate, tin(II) octoate, tin(II) ethylhexoate and tin(II) laurate, and the dialkyltin(IV) salts of organic carboxylic acids, e.g. dibutyltin diacetate, dibutyltin dilaurate, dibutyltin maleate and dioctyltin diacetate, and bismuth carboxylates, such as bismuth(III) neodecanoate, bismuth 2-ethylhexanoate and bismuth octanoate, or mixtures thereof are also suitable. The organic metal compounds can be used alone or preferably in combination with strongly basic amines. In particular, tin-free catalyst systems are used, such as catalyst systems comprising organic metal compounds based on bismuth in combination with strongly basic amines. Such tin-free catalyst systems are described, for example, in EP 1720927.

Preferably from 0.001 to 5% by weight, in particular from 0.05 to 2% by weight, of catalyst or catalyst combination, based on the weight of the components (b), (c) and (d), are used.

Furthermore, blowing agents (f) are present during the preparation of flexible integral polyurethane foams. These blowing agents comprise water. Apart from water, generally known chemically and/or physically acting compounds may additionally be used as blowing agents (f). Chemical blowing agents are understood as meaning compounds which form gaseous products, such as, for example, water or formic acid, by reaction of isocyanate. Physical blowing agents are understood as meaning compounds which are dissolved or emulsified in the starting materials of the polyurethane preparation and vaporize under the conditions of the polyurethane formation. These are, for example, hydrocarbons, halogenated hydrocarbons and other compounds, such as, for example, perfluorinated alkanes, such as perfluorohexane, chlorofluorocarbons, and ethers, esters, ketones and/or acetals, for example (cyclo)aliphatic hydrocarbons having 4 to 8 carbon atoms, or fluorohydrocarbons, such as Solkane® 365 mfc from Solvay Fluorides LLC. In a preferred embodiment, water is used as the sole blowing agent.

In a preferred embodiment, the content of water is from 0.1 to 2% by weight, preferably from 0.2 to 1.8% by weight, particularly preferably from 0.3 to 1.5% by weight, in particular from 0.4 to 1.2% by weight, based on the total weight of the components (b) to (f).

In a further preferred embodiment, hollow microspheres which comprise physical blowing agents are added to the reaction of the components (a) to (f) and, if appropriate, (g) as additional blowing agent. The hollow microspheres can also be used as a mixture of the abovementioned additionally chemical blowing agents and/or physical blowing agents.

The hollow microspheres usually consists of a shell of thermoplastic polymer and are filled in the core with a liquid, low-boiling substance based on alkanes. The preparation of such hollow microspheres is described, for example, in U.S. Pat. No. 3,615,972. The hollow microspheres generally have a diameter of from 5 to 50 μm. Examples of suitable hollow microspheres are available under the trade name Expancell® from Akzo Nobel.

The hollow microspheres are added in general in an amount of from 0.5 to 5% by weight, based on the total weight of the components (b) to (f).

If appropriate, assistants and/or additives (g) may also be added to the reaction mixture for the preparation of polyurethane foams. Surface-active substances, foam stabilizers, cell regulators, release agents, fillers, dies, pigments, hydrolysis stabilizers, odor-absorbing substances and fungistatic and/or bacteriostatic substances may be mentioned by way of example.

Suitable surface-active substances are, for example, compounds which serve for promoting homogenization of the starting materials and, if appropriate, are also suitable for regulating the cell structure. Emulsifiers, such as the sodium salts of castor oil sulfates or of fatty acids, and salts of fatty acids with amines, e.g. of diethylamine with oleic acid, of diethanolamine with stearic acid and of diethanolamine with ricinoleic acid, salts of sulfonic acids, e.g. alkali metal or ammonium salts of dodecylbenzenedisulfonic acid or dinaphthylmethanedisulfonic acid, and ricinoleic acid; foam stabilizers, such as siloxane-oxyalkylene copolymers and other organopolysiloxanes, oxyethylated alkylphenols, oxyethylated fatty alcohols, liquid paraffins, castor oil esters or ricinoleic acid esters, Turkey red oil and peanut oil, and cell regulators, such as paraffins, fatty alcohols and dimethylpolysiloxanes, may be mentioned by way of example. For improving the emulsifying effect of the cell structure and/or stabilizing the foam, oligomeric acrylates having polyoxyalkylene and fluoroalkane radicals as side groups are furthermore suitable. The surface-active substances are usually used in amounts of from 0.01 to 5 parts by weight, based on 100 parts by weight of the components (b) to (d).

The following may be mentioned by way of example as suitable release agents: reaction products of fatty acid esters with polyisocyanates, salts of polysiloxanes comprising amino groups and fatty acids, salts of saturated or unsaturated (cyclo)aliphatic carboxylic acids having at least 8 carbon atoms and tertiary amines, and in particular internal release agents, such as carboxylic esters and/or carboxamides, prepared by esterification or amidation of a mixture of montanic acid and at least one aliphatic carboxylic acid having at least 10 carbon atoms with at least difunctional alkanolamines, polyols and/or polyamines having molecular weights of from 60 to 400 g/mol, as disclosed, for example, in EP 153 639, mixtures of organic amines, metal salts of stearic acid and organic mono- and/or dicarboxylic acids or anhydrides thereof, as disclosed, for example, in DE-A-3 607 447, or mixtures of an imino compound, the metal salt of a carboxylic acid and, if appropriate, a carboxylic acid, as disclosed, for example, in U.S. Pat. No. 4,764,537.

Fillers, in particular reinforcing fillers, are to be understood as meaning the customary organic and inorganic fillers, reinforcing agents, weighting agents, coating materials, etc. which are known per se. The following may be mentioned specifically by way of example: inorganic fillers, such as silicate minerals, for example phyllosilicates, such as antigorite, bentonite, serpentine, hornblendes, amphibole, chrysotile and talc, metal oxide, such as kaolin, aluminas, titanium oxide, zinc oxide and iron oxide, metal salts, such as chalk and barite, and inorganic pigments, such as cadmium sulfide and zinc sulfide, and glass, etc. Kaolin (China Clay), aluminum silicate and coprecipitates of barium sulfate and aluminum silicate and natural and synthetic fibrous minerals, such as wollastonite, metal and in particular glass fibers of various lengths, which, if appropriate, may be sized, are preferably used. Examples of suitable organic fillers are: carbon black, melamine, rosin, cyclopentadienyl reins and graft polymers and cellulose fibers, polyamide, polyacrylonitrile, polyurethane and polyester fibers based on aromatic and/or aliphatic dicarboxylic esters and in particular carbon fibers.

The inorganic and organic fillers may be used individually or as mixtures and are added to the reaction mixture advantageously in amounts of from 0.5 to 50% by weight, preferably from 1 to 40% by weight, based on the weight of the components (b) to (d), but the content of mats, nonwovens and woven fabrics of natural and synthetic fibers may reach values of up to 80% by weight.

The components (a) to (g) are mixed together for the preparation of a composite material according to the invention in amounts such that the ratio of the number of equivalents of NCO groups of the polyisocyanate prepolymers (a) to the sum of the reactive hydrogen atoms of the components (b), (c), (d) and (f) is from 1:0.8 to 1:1.25, preferably from 1:0.9 to 1:1.15. In the invention, the mixture of the components (a) to (f) and, if appropriate, (g) in the case of reaction conversions of less than 90%, based on the isocyanate groups, is referred to as reaction mixture.

The flexible integral polyurethane foams according to the invention are preferably prepared by the one-shot process with the aid of the low pressure or high pressure techniques in closed, expediently thermostatic molds. The molds usually consist of metal, e.g. aluminum or steel. These procedures are described, for example, by Piechota and Rohr in “Integralschaumstoff”, Carl-Hanser-Verlag, Munich, Vienna, 1975, or in “Kunststoffhandbuch”, volume 7, Polyurethane, 3rd edition, 1993, chapter 7.

For this purpose, the starting components (a) to (f) and, if appropriate, (g) are preferably mixed at a temperature of from 15 to 90° C., particularly preferably from 25 to 55° C., and the reaction mixture is introduced into the closed mold, if appropriate, under superatmospheric pressure. The two-component process is preferably employed thereby. For this purpose, a polyol component comprising the components (b) to (f) and, if appropriate, (g) is initially prepared, which polyol component forms the A-component. This is then mixed with the isocyanate component, the so-called B-component, comprising the isocyanate prepolymers (a), in the preparation of the reaction mixture. The mixing can be carried out mechanically by means of a stirrer or of a stirring screw or under high pressure in so-called countercurrent injection processes. The mold temperature is expediently from 20 to 160° C., preferably from 30 to 120° C., particularly preferably from 30 to 60° C.

The amount of reaction mixture introduced into the mold is such that resulting moldings of the integral foams have a density of from 150 to 350 g/L, in particular from 150 to 300 g/L. The degrees of compaction for the preparation of flexible integral polyurethane foams are preferably in the range of from 1.1 to 8.5, particularly preferably in the range of from 1.8 to 7.0.

Flexible integral foams according to the invention are distinguished by very good mechanical properties, such as, in particular, hardness of 55 Asker C and tensile strength. Furthermore, the flexible integral polyurethane foams according to the invention can be prepared without problems and show outstanding dimensional stability and no surface defects, such as peeling of the skin layer or blow holes.

Below, the invention is illustrated with reference to examples.

### EXAMPLES

### Starting Materials Used

4,4′-MDI, commercially available from Elastogran GmbH
Lupranat MM103: carbodiimide-modified, 4,4′-MDI
Polyol 1: Polyetherol based on propylene glycol and propylene oxide having an OH number of 55 mg KOH/g and a viscosity of 325 mPas at 25° C.
Polyol 2: Polyetherol based on propylene glycol, propylene oxide and ethylene oxide having an OH number of 29 mg KOH/g and a viscosity of 775 mPas at 25° C.
Polyol 3: Polyetherol based on glycerol, propylene oxide and ethylene oxide having an OH number of 27 mg KOH/g and a viscosity of 5270 mPas at 25° C.
Polyol 4: Lupranol 4800 from Elastogran GmbH; polymer polyetherol having a solids content of 45% by weight and an OH number of 20 mg KOH/g.
KV1: Chain extender monoethylene glycol
KV2: chain extender 1,4-butanediol
KV3: Tripropylene glycol
KAT1: Dabco dissolved in MEG
KAT2: N,N,N′N′-Tetramethyl-2,2′-oxybis(ethylamine) dissolved in dipropylene glycol
KAT3: Metal catalyst based on bismuth
KAT4: Metal catalyst based on tin
KAT5: Catalyst based on imidazole derivatives
KAT6: Incorporatable catalyst based on imidazole derivatives
FD: Free density
SAD: Shaped article density

The isocyanate prepolymers ISO A and ISO B used were prepared according to Table 1.

TABLE 1

| | ISO A | ISO B |
|---|---|---|
| Lupranat MES | 61.40 | 56.90 |
| Lupranat MM103 | 2.00 | 2.00 |
| Polyol 1 | 32.50 | 41.10 |
| KV3 | 4.00 | 0.00 |

The NCO content of ISO A and ISO B is 18.0% in each case.

The polyurethane moldings were produced by mixing the polyisocyanate prepolymers ISO A or ISO B with a polyol component. The compositions of the polyol components used and the isocyanate prepolymer used in each case and the isocyanate index are stated in Table 2. There, C1 to C4 are comparative experiments 1 to 4 and E1 to E3 are examples 1 to 3 according to the invention.

TABLE 2

| | C1 | C2 | C3 | C4 | E1 | E2 | E3 |
|---|---|---|---|---|---|---|---|
| Polyol 2 | 85.46 | 42.76 | | | | | |
| Polyol 3 | | 42.75 | 85.57 | 55.11 | 52.42 | 52.45 | 59.01 |
| Polyol 4 | | | | 30.81 | 30.00 | 30.74 | 28.87 |
| KV1 | 8.56 | 8.53 | 8.49 | 8.39 | 8.18 | 8.37 | 7.04 |
| KV2 | 2.67 | 2.66 | 2.65 | 1.95 | 3.19 | 1.95 | 2.26 |
| Water | 1.49 | 1.48 | 1.48 | 1.13 | 1.40 | 1.18 | 1.10 |
| KAT1 | 1.39 | 1.38 | 1.38 | 1.30 | 1.00 | 1.30 | 1.10 |
| KAT2 | 0.39 | 0.39 | 0.39 | 0.32 | 0.41 | 0.33 | 0.51 |
| KAT3 | | | | 0.32 | | 0.32 | 0.06 |
| KAT4 | 0.05 | 0.05 | 0.05 | | 0.05 | | |
| KAT5 | | | | 0.34 | 0.40 | 0.34 | |
| KAT6 | | | | 0.26 | 0.27 | 0.26 | |
| Black pastes | | | | | 2.92 | | |
| Isocyanate | ISO | ISO | ISO | ISO | ISO | ISO | ISO |
| | A | A | A | B | A | A | A |
| Index | 96 | 96 | 96 | 100 | 98 | 100 | 98 |

Table 3 provides information about the properties of the PU moldings according to comparative examples C1 to C4 and examples E1 to E3 according to the invention:

TABLE 3

| | C1 | C2 | C3 | C4 | E1 | E2 | E3 |
|---|---|---|---|---|---|---|---|
| Cream time [s] | 11 | 11 | 10 | 6 | 7 | 7 | 6 |
| Rise time [s] | 40 | 39 | 34 | 22 | 40 | 28 | 34 |
| FD [g/L] | 118 | 119 | 119 | 170 | 111 | 158 | 137 |
| SAD [g/L] | 250 | 250 | 250 | 250 | 250 | 250 | 250 |
| Hardness [Asker C] | 53 | 52 | 54 | 53 | 55 | 58 | 55 |
| Shrinkage [%] | −1 | −1 | −1.1 | −1.0 | −1.1 | −1.0 | −1.1 |
| Tensile strength | 0.6 | 1.2 | 1.6 | 1.2 | 1.9 | 2.2 | 2.2 |
| [N/mm²] | | | | | | | |
| Elongation [%] | 97 | 225 | 248 | 146 | 223 | 223 | 249 |
| Resilience [%] | 26 | 27 | 27 | 33 | 20 | 26 | 26 |

1. A process for the production of a polyurethane molding having a density of from 150 to 350 g/l, comprising mixing
a polyisocyanate prepolymer comprising a polyisocyanate component, a polyol comprising polypropylene oxide having a number-average molecular weight of from 1000 to 7000 g/mol, and a chain extender,
a polyetherpolyol having an average functionality greater than 2.0, prepared by anionic polymerization with alkali metal hydroxide or cationic polymerization with a Lewis acid,
a polymer polyetherpolyol,
a chain extender,
a catalyst,
a blowing agent, comprising water,
to give a reaction mixture and curing said reaction mixture in a mold to give a polyurethane molding.

2. The process for the production of a polyurethane molding according to claim 1, wherein the polyisocyanate prepolymer has an NCO content of from 8 to 28%.

3. The process for the production of a polyurethane molding according to claim 1, wherein the chain extender comprises tripropylene glycol.

4. The process for the production of a polyurethane molding according to claim 1, wherein the polyetherpolyol is a trifunctionally initiated polyether polyol.

5. The process for the production of a polyurethane molding according to claim 1, wherein the chain extender is 1,4-butanediol or monoethylene glycol, or mixtures thereof.

6. The process for the production of a polyurethane molding according to claim 5, wherein the chain extender is a mixture of 1,4-butanediol and monoethylene glycol.

7. A polyurethane molding obtainable by a process according to claim 1.

8. A shoe sole comprising a polyurethane molding according to claim 7.

9. A process for the production of a polyurethane molding according to claim 1, further comprising at least one further assistant or additive.
